(19) United States
(12) Patent Application Publication
(10) Pub. No.: US 2004/0241407 A1
(43) Pub. Date: Dec. 2, 2004

(54) Methods of making thick, highly oriented, opaque, low-density, microporous polyolefin films and the films made thereby

(75) Inventors: Leo M. Landoll, Hockessin, DE (US); Kelan Wieloch, Boothwyn, PA (US)

Correspondence Address: CAESAR, RIVISE, BERNSTEIN,, COHEN & POKOTILOW, LTD., 11TH FLOOR, SEVEN PENN CENTER, PHILADELPHIA, PA, 19103-2212, US

(73) Assignee: Applied Extrusion Technologies, Inc., New Castle, DE (US)

(21) Appl. No.: 10/834,153

(22) Filed: Apr. 28, 2004

Related U.S. Application Data
(60) Provisional application No. 60/468,846, filed on May 8, 2003.

(51) Int. Cl. B32B 1/00

(52) U.S. Cl. 428/219; 264/210.1; 264/290.2; 428/220

(57) ABSTRACT

A method of making a polyolefin film in accordance with this invention includes the steps of: blending a propylene block copolymer with a beta nucleating agent; extruding a film layer from the blend and providing a total area draw ratio in excess of 20, where at least one part of the stretching occurs at <120° C., for forming the film with a density no greater than 0.40 g/cm³ and a thickness greater than 160 gauge. The film also constitutes a part of this invention

### RELATED APPLICATIONS

This application claims the benefit of earlier-filed provisional application Serial No. 60/468,846 filed on May 8, 2003.

### BACKGROUND OF THE INVENTION

This invention relates generally to plastic films and more specifically to low density, beta-polypropylene films and methods of making those films employing a beta nucleating agent.

Disclosures of beta-polypropylene films, which are films made from a beta-crystal nucleated precursor, are prevalent in the patent literature. These films can offer unique characteristics, such as high opacity, high air permeability, high WVTR, good printability, no dusting and high strength properties. However, the prior art discloses methods of making these films employing low area draw ratios in order to achieve desired film properties. In particular, the prior art teaches that as area draw ratios increase, density, opacity and WVTR properties deteriorate such that the lowest density, highest WVTR, and highest opacity occur at area draw ratios less than ˜10. However, carrying out the film forming process at the low area draw ratios taught in the prior art results in a process that is not very cost effective.

Reference to “area draw ratio” or “area draw ratios” means the product of the machine direction (MD) draw and the transverse direction (TD) draw. For example, if a film is drawn 2 times its length in the MD and 7 times its width in the TD, then the area draw ratio is 14 (i.e., 2×7).

Various methods for making opaque, low density, highly oriented polypropylene films are known in the prior art. Exemplary methods include: incorporating inorganic and/or organic particulate fillers in a polymer extrudate, blending incompatible polymers in a polymer extrudate, extracting previously added materials from a polymer, and beta nucleation techniques.

Using inorganic fillers to create an opaque film is widely disclosed in the patent literature, e.g., U.S. Pat. Nos. 3,407,253, 3,844,865, 3,903,234, 4,335,193, 4,613,643, 4,698,372, 4,705,813, 5,008,296, 5,236,593 and 5,910,136. Fillers such as barium sulfate, calcium carbonate, clay, talc, or titanium dioxide are blended into a polymer and initiate cracks during the stretching process. The cracks then expand into larger voids upon further stretching. The fillers have significantly higher density than polypropylene. This must be offset by a large void fraction in order to achieve adequate economy. With such a high void volume, the stiffness values are sacrificed at a given coverage because the filler takes up a significant amount of the weight. The films also have poor tear properties and dusting problems when particles break loose from the matrix.

Organic fillers work just like the inorganic fillers but they typically have a lower density. However, they still suffer the same density detriment since the particles unnecessarily add to the weight of the material. Organic fillers also are typically much more expensive than inorganic fillers such as diatomaceous earth, thereby reducing economy of production.

Blending incompatible polymers is disclosed in many patents such as U.S. Pat. Nos. 3,969,562, 4,105,737, and 6,444,302. By drawing under specific conditions, cracks are created at the interface of the polymers. Stretching can then enlarge the cracks and create a porous film. Using this method, however, requires an additional blending step to incorporate both materials into a melt. The materials used as the dispersed phase are also more expensive than polypropylene. Finally there are voiding limitations based on the polymers used because of the thermodynamic phase separation and process control requirements.

Extraction techniques are disclosed in U.S. Pat. Nos. 4,100,238, 4,247,498, 4,335,193, 4,386,129, 4,490,431, 4,829,096, and 4,959,396. In accordance with this method two different materials are blended together: one soluble in a particular solution, the other insoluble. Either in place of stretching, or before or after stretching, the film is run through a solvent bath to remove the soluble material, leaving the insoluble one behind. This process can create highly porous materials and uniform pore sizes, but the extraction step is difficult to control and is very inefficient and costly.

Beta nucleation processes rely on the density difference between alpha and beta crystals and the weak interface between beta crystals and the amorphous phase to initiate and propagate cracks. By slowly cooling from a melt, a propylene-based polymer with a beta-nucleating agent will preferentially form beta crystals. When stretched cold, the beta crystals transform into alpha crystals and crack between the crystal and the amorphous phase. The resulting voids can be enlarged by stretching to create an opaque, microporous, low-density polypropylene film. Prior art patents and other publications disclosing beta-nucleating techniques are disclosed and discussed hereinafter.

Prior Art Relating to Beta-Polypropylene

Sato et al. U.S. Pat. Nos. 4,138,520 and 4,185,148 disclose methods for producing films from a beta crystalline precursor by casting a material under a high thermal gradient to create beta crystals on one side. Those films are not area draw limited, but the beta crystals are formed through a high thermal gradient and limited to one side of the film. This patent is directed to forming a clear, airtight film, not an opaque, porous structure of the type formed in accordance with this invention. Furthermore, this method cannot be employed to gain the benefit of low density because the beta crystals are limited to one side, thus cannot produce voids throughout the entirety of the film.

Jacoby et al. U.S. Pat. No. 4,386,129 discloses a method for making a porous sheet by casting a polypropylene based film with a beta nucleating agent to provide a high percentage of beta crystals. The beta crystals can then be selectively extracted using a nonpolar organic solvent, such as toluene, xylene or carbon tetrachloride. The resulting film, while porous and having a low density, is not stretched. The disclosure in this patent is exemplary of the prior art extraction technique referred to earlier herein.

U.S. Pat. No. 4,975,469 builds upon the previous work disclosed in the Jacoby et al. '129 patent and specifically discloses stretching the film after the extraction step to improve breathability. The data in the '469 patent shows that a total area stretch ratio of 4 to 7 improves water vapor transmission rates of the films.

U.S. Pat. No. 5,134,174 uses a beta polypropylene precursor with a high beta crystal content. The precursor is stretched 1.5 to 20 total area draw (preferably 2-10) followed by a heat set stage, which increases porosity and air permeation coefficients. The resulting films have a porosity of 30-40% and high tensile strength. For a polymer having a starting density of about 0.91 g/cm³, which is common for polypropylene, a porosity of 40% corresponds to a density of 0.54 g/cm³. The present invention employs higher area draw ratios to achieve higher porosity values (lower density), either with or without a heat set process, while achieving other properties and benefits that were heretofore not believed to be possible.

U.S. Pat. No. 5,491,188 discloses a process for producing a porous polypropylene film from a beta crystal precursor. The precursor is made by combining a propylene-based polymer with an amide-based beta-nucleating agent. This blend is melted and crystallized to yield a high percentage of beta crystals. The casting is then stretched between 20° C. and the melting point of the beta crystals. The extent of stretching is not limited, and the resulting products are claimed to have porosity between 10% and 80%. The examples show that a maximum porosity of 40.2% was achieved with an area draw ratio of 4.4. The highest disclosed area draw ratio of only 7.3 had a slightly reduced porosity of 39.0%. The disclosed maximum preferred stretching conditions are 2.8×2.6. The disclosure in the '188 patent is consistent with previous disclosures in the literature; namely, that porosity increases up to a certain (low) area draw ratio, after which it starts to decline. This clearly suggests that when low-density structures are required the area draw ratio should be kept low, which adversely effects economics and is in contrary to the invention disclosed herein.

A publication in Polymer entitled “Structure and Gas Permeability of Microporous Films Prepared by Biaxial Drawing of Beta-Form Polypropylene,” shows data that porosity and gas permeability reach a maximum at a low area draw ratio (˜3.1) and then starts to diminish. The highest porosity of 40% corresponds to a density of 0.54 g/cm³, based on a standard polypropylene starting density of 0.91 g/cm³. Chu, F. and Kimura, Y, Polymer 1996, 37, 573. This also is in distinction to the invention disclosed herein.

U.S. Pat. No. 5,594,070, to Jacoby et al., discloses a composition for highly breathable films. A polypropylene based resin with a beta-nucleating agent is cast to crystallize a high percentage of beta crystals. By incorporating a low molecular weight polypropylene species, the WVTR is increased significantly. The stretch ratios that are employed are the same as are taught in the prior art literature. In accordance with the invention disclosed in the '070 patent the total area draw ratio is less than 7, and one example shows that a 3× uniaxial orientation produces better WVTR than a 2×2 biaxial orientation.

U.S. Pat. No. 6,368,742 discloses a material suitable for a battery separator. This material is made from a beta polypropylene precursor and the patent discloses employing a maximum draw ratio of 6×6. The resulting films have good electrical resistance and have a puncture resistance greater than 400 grams force per mil of thickness. The specific examples disclose area draw ratios up to 18 and no higher. The highest area draw ratios do not produce films having the highest porosity, showing the trends of all previous literature that the highest porosity is achieved at very low draw ratios. The base resin is polypropylene, not a propylene block copolymer, as the instant invention requires. The precursor casting material has a beta crystal content of 46-60% even though beta crystal contents exceeding 60% can be easily achieved. In accordance with the instant invention, beta crystal content is preferentially maximized, such that the highest beta crystal content is best suited to realize the enhanced properties. With lower beta crystal contents, <23%, not all the enhanced properties are realized. In addition, the disclosed TD stretching limitations in the '742 patent are narrower than are permitted in the instant invention. Thus, the instant invention allows a greater operating window, better economics, lower density, higher draw ratios and thicker, stiffer films.

U.S. Pat. No. 6,444,301 discloses an improved film for label applications made from a beta-nucleated precursor, which has good static dissipation. These films have high stretch ratios, but the patent teaches through its examples that lower stretch ratios lead to increased voiding. The patent also uses a polypropylene homopolymer and an ethylene/propylene random copolymer but not an ethylene/propylene block copolymer. In accordance with the instant invention, when an ethylene/propylene block copolymer is employed, stretch ratios higher than disclosed in the prior art can be employed without decreasing voiding. The films of the '301 patent can range from 40 to 80 microns in total thickness, whereas films of the instant invention can range from 40 up to 250 microns.

U.S. patent application 2002/0137851 A1 discloses a composition that has good drawability over a wide temperature range. By employing a polypropylene based material with a high beta crystal content, a melt tension at 230° C. of at least 5 cN and 0.01% to 10% of a polymer species with a molecular weight of at least 1,000,000, good drawability is realized. The resulting films have porosity up to 75% and the area draw ratio is up to 50, which is suitable for commercial production. The invention disclosed in this published application requires a high molecular weight species, which is not required in the instant invention. The data included with the examples of U.S. patent application 2002/0137851 A1 do not teach how to draw the film or any methods to keep the density low (or porosity high) at the high draw ratios required in the instant invention.

European Patent Application EP 1 291 380 A1 discloses the use of a propylene-ethylene copolymer or blend of polymers with a composite ethylene content of 3.0%-7.0%, a composite MFR at 230° C. of 2.0-4.0 g/10 min, and a β-crystal nucleating agent to produce a film with a porosity of 20-80%, a Gurley air permeability of 5,000 sec/100 cc or lower, a WVTR of at least 2000 g/(m²·day), and a water pressure resistance of 75 kPa or higher. There are several key differences between the European application and the instant invention. 1) The C₂ content and MFR limitations do not exist with this application. The instant invention encompasses films with a C₂ content between 2 and 11% and a composite MFR between 1.2 and 8.0 g/10 min. 2) Higher area draw ratios do not increase density (decrease porosity). In fact, as reported in Table 2 of the European application, the three samples having porosity values of at least 40% are samples 4 (porosity of 44%), 7 (porosity of 50%), and 9 (porosity of 40%). In all three, the total area draw ratio was 20, with higher total area draw ratios resulting in lower porosity values, teaching that the lowest density will be achieved with lower area draw ratios. 3) The film densities are different. The highest porosity (lowest density) the European application achieved was 50% (corresponding to a density of 0.45 g/cm³) at an area draw ratio of 20. Films of the instant invention have a density of 0.24-0.40 g/cm³ (76-54% porosity) with area draw ratios well over 40. 4) The examples in Table 2 of the European application only show films between 14 and 26 micron in thickness, whereas the instant invention is suited for films between 40 and 250 micron.

### SUMMARY OF THE INVENTION

A method of making a polyolefin film in accordance with this invention includes the steps of: blending a propylene block copolymer with a beta nucleating agent; extruding a film layer from said blend and providing a total area draw ratio in excess of 20, where at least one part of the stretching occurs at <120° C., for forming the film with a density no greater than 0.40 g/cm³ and a thickness greater than 160 gauge.

In the preferred method the block copolymer is a propylene/ethylene block copolymer. Preferably the density of the film formed in accordance with the process of this invention is under 0.35 g/cm³ and more preferably under 0.30 g/cm³.

In the preferred embodiments of this invention the total area draw ratio is at least 30; more preferably at least 35 and even more preferably at least 40.

A biaxially oriented polyolefin film in accordance with this invention includes a blend of a propylene block copolymer and a beta nucleating agent, has a density less than 0.40 g/cm³ and a thickness greater than 160 gauge. In the preferred film the block copolymer is at least 20% of the composition of the film and preferably is a propylene/ethylene block copolymer.

This invention relates to methods of forming thick, low density polypropylene films at higher area draw ratios than the prior art suggested was possible before properties started to deteriorate, to thereby achieve a reduced cost of manufacture and improved coverage while still achieving desired properties. The films made in accordance with the methods of this invention also are part of the invention and are thick, opaque, low density, highly oriented, microporous polypropylene films having greater stiffness and coverage than other opaque polyolefin films.

Reference to “improved coverage” means that the films made in accordance with the methods of this invention either have a greater area yield per unit weight of material relative to comparable prior art structures, or that the films have the same area yield as such prior art structures, but with the use of less material.

In accordance with this invention the films are made by blending a propylene block copolymer, preferably a propylene/ethylene block copolymer, with a beta-nucleating agent. Additionally 80% or more of compatible polymers or other additives known in the art can be included to provide additional enhancements. Additives include but are not limited to polypropylene, olefin random copolymers, e.g., propylene/ethylene copolymers, preferably containing 4% or less ethylene, and propylene/butene copolymers, preferably containing less than 14% butane and more preferably about 10% butene, polyethylene, metallocene-catalyzed polypropylene, skin layers, calcium carbonate, titanium dioxide, or other additives such as antistat agents, antiblock agents, migratory slip agents, antioxidants, organic or inorganic voiding agents, etc. The blend is extruded, crystallized at a high temperature (between 60° C. and 135° C.) for several seconds (10 seconds or more), and then stretched biaxially with at least the stretching in one direction being performed at a low temperature (<120° C.). Area draw ratios are preferentially maximized to increase stiffness properties and to enhance economy of production. In accordance with this invention increased area draw ratios are employed without adversely diminishing other important film properties, contrary to the teachings of the prior art.

Through a combination of polymer selection and process conditions, the methods of this invention result in the economic production of films of this invention at a reduced cost and lower density relative to prior art processes. The lower density of these films results in other significant advantages over comparable prior art films, to wit: 1) improved stiffness—at a fixed coverage, the thickness is higher resulting in higher film stiffness; 2) larger coverage (or area yield per pound of film); 3) thicker films and 4) high porosity (low density), which can lead to high WVTR (water vapor transmission rate).

In accordance with this invention the films are produced economically with high area draw ratios (e.g., over 20 to 70) without losing desired physical properties, such as stiffness, density, or WVTR. Prior art films having high WVTR do not have low density or high thickness because they employ low are draw ratios of less than about 10. With the use of higher area draw ratios in accordance with this invention, the production costs are improved. Moreover, the production capabilities are greater than in methods for making similar products at a low area draw ratio because the films of this invention can be easily produced on existing commercial equipment.

Another unique aspect of the films of this invention is their printability on ink jet printers. Without using a coating, a surfactant, or even surface treatment (e.g., flame, corona, or plasma), films of this invention can be printed in an ink jet printer and dry within seconds of ink application. Although the material is hydrophobic and does not absorb water, it accepts ink from a cartridge and dries quickly due to its high porosity and interconnected pore structure. Water droplets resting on the surface do not penetrate the film, but ink enters the pores at the surface and spreads out into the film. With a high porosity, the film accepts the ink and holds it, while the high WVTR allows it to dry. The printed appearance is not perfect because the large pore size tends to cause some ink bleed, but the ink still dries and stays in place despite the film being composed solely of polymer and a beta nucleating agent. Other microporous polyolefin films do not share this unique feature.

Because the films of the present invention can be made economically while retaining useful properties, they can be used in a variety of applications. These include but are not limited to: breathable garments, breathable waterproof garments, battery separators, house wrap, personal hygiene or sanitary products, filtration media, synthetic paper media (e.g., ink jet printable substrates), bottle labels, sheet labels, other packaging materials, or other absorbent materials.

### PREFERRED EMBODIMENTS OF THE INVENTION

The films formed in accordance with this invention are thick, highly oriented, low-density, opaque, microporous films made from a beta-polypropylene precursor. The precursor is made from a propylene block copolymer, preferably a propylene/ethylene block copolymer and a beta-nucleating agent. Polypropylene cannot be used alone because it does not stretch uniformly, and random copolymers cannot be used because they do not crystallize to the beta form as readily. The preferred block copolymer is a propylene/ethylene block copolymer with an MFR between about 1.0 and 10.0 g/10 min and an ethylene block component between about 4% and 11%. The above-identified MFR and ethylene content are not intended to be limitations on the broadest aspects of this invention, but they describe the range of block copolymers that have been used successfully to-date. Although values outside the above-stated range have not been tested, but there is no reason to believe that block copolymers having other values will not work. It has been determined that a blend of 18% of a propylene/ethylene block copolymer and 82% of a propylene homopolymer with a composite MFR of 1.2 g/10 min and a composite ethylene content of ˜2% did not produce a film of this invention. However, other material blends with an MFR of 1.2 have produced films of this invention and other blends with a composite ethylene content of 2% have also produced films of this invention. Applicants believe that the reason why the blend of 18% propylene/ethylene block copolymer and 82% propylene homopolymer did not produce a desirable film in accordance with this invention may have been due to the particular combination of materials and has nothing to do with the MFR and ethylene content of that combination.

In many cases, other materials can enhance the drawability, density, stiffness, opacity or WVTR properties of the films of this invention, such as polypropylene (either Ziegler-Natta or metallocene-catalyzed), polyethylene, or polybutene. They can be added to produce a blend that will not sacrificing the desirable properties as long as the propylene/ethylene block copolymer constitutes at least about 20% by weight of the polymers in the blend. In addition to polymers, other additives can be utilized, although it is preferable to keep the level of additives low enough so as to not increase significantly the density of the film. Calcium carbonate can increase the WVTR, as can other organic or inorganic voiding agents. Antistatic agents, migratory and non-migratory slip agents, UV stabilizers, antioxidants, antacids, and heat and light stabilizers, and pigments such as titanium dioxide can all be added without adversely affecting the properties of the films of this invention.

The beta nucleating agents usable in this invention are conventional nucleating agents well known to those skilled in the art, e.g., γ-quinacridone, a group II metal salt and an organic di-acid compound (U.S. Pat. No. 5,231,126), or N,N′-dicyclohexyl-2,6-naphthalene (U.S. Pat. No. 6,235,823). The amount of beta nucleating agent employed is not a limitation on the broadest aspects of this invention, provided however that it should yield a K value greater than 0.23 for the given crystallization temperature. (K is the ratio of beta crystals to the total crystallinity, usually measured by WAXS. It is calculated using the equation K=H₍₃₀₀₎/[H₍₃₀₀₎+H₍₁₁₀₎+H₍₀₄₀₎+H₍₁₃₀₎] where H corresponds to the peak height of the four main crystal reflections.)

The material blend is extruded and crystallized at a temperature suitable for preferentially forming beta crystals. This temperature depends on the amount and type of the nucleating agent used, but it generally will be in the range between about 60° C. and about 135° C. Higher temperatures cause sticking and do not form beta crystals until the sheet is further cooled. At temperatures lower than ˜60° C., few beta crystals are formed. For the highest beta crystal content, crystallization is preferentially between about 90° C. and about 125° C. The specific temperature to be employed can easily be determined by a person skilled in the art without an undue amount of experimentation. The time required to crystallize is also critical to forming a high beta crystal content. The preferred time is at least 15 seconds, but that is also a function of the amount and efficiency of the beta nucleating agent and the temperature at which crystallization is carried out. Films with low density can still be manufactured without a high beta crystal content but WVTR will be sacrificed. In order to achieve high WVTR, casting temperature should be at least 90° C. for at least 20 seconds. Following the crystallization step the film is biaxially oriented. This biaxial orientation step can be either simultaneous or sequential. If it is done simultaneously, it must be done below 120° C. in order to achieve low density and high voiding as required in this invention.

If biaxial orientation is carried out sequentially, the first orientation step is performed in the machine direction at a temperature between about 60° C. and 120° C., and preferably between about 77° C. and about 104° C. Below about 77° C. breaks are more frequent and above about 104° C., WVTR is lowered. Low density films can still be made with machine-direction orientation (MDO) temperatures up to 120° C., but a sacrifice in WVTR is likely. Preferably, the draw ratio in the machine direction is between about 3.0 and 7.0×. For sequential draw, the second draw step, which is in the cross machine direction, can be done at any temperature suitable for film production, preferably between about 130° C. and about 155° C. Above about 155° C., voids start to collapse, increasing density of the film. The draw ratio in this cross machine direction is not limited but it preferably is in the range between 6 and 10×. Moreover, the machine direction and cross direction draw ratios are selected to achieve a total area draw ratio (machine direction draw×cross direction draw) in excess of 20, more preferably at least 30. In fact, total area draw ratios in excess of 50 have been employed in this invention, as will be shown in the examples disclosed subsequently herein.

In accordance with this invention, the high total area draw ratios are employed to provide films with a density no greater than 0.40 g/cm³ (56% porosity), more preferable under 0.35 g/cm³ (61% porosity), and most preferable 0.30 g/cm³ or lower (67% porosity and higher). As noted in the data related to the reported samples, but not by way of limitation, a density as low as 0.25 g/cm³ (72% porosity) was achieved in a film having a total area draw of 46 (see sample 2).

In order to make films with such low density, it is also necessary to keep the thickness high (greater than 40 micron). Lower thicknesses have an increased frequency of breakage. The upper thickness range however is unbounded. One sample was made at 246 micron, but thicker films can be made.

Films made from beta polypropylene having high opacity, high WVTR and low density are reported in the prior art. The films of the present invention retain all these desired properties and in addition have high orientation, lower density, higher thickness, easier production on existing equipment, and more favorable economics than have been achieved in the prior art. The very low density produces improved stiffness and coverage. Films of the instant invention with the same coverage as conventional opaque voided films will be much thicker (˜twice as thick) due to the lower density. This gives an enormous stiffness advantage by itself. Alternatively, a film of the instant invention with the same stiffness as a conventional voided film would have a higher coverage due to the low density. It is important to note that the stiffness and coverage values are not limited to any specific range. As coverage decreases, stiffness increases and vice versa. When compared to a conventional voided film however, the films of the instant invention will have superior coverage, superior stiffness, or both. In accordance with the instant invention, the higher area draw ratios employed to provide enhanced economics do not adversely reduce the above enumerated, desired properties and benefits, a result that is contrary to the teachings in the current literature. The following examples demonstrate the improvements obtained from the higher area draw ratios and superior physical properties of the films of this invention.

Test Methods

Yield was measured by ASTM test method D4321-95. Three 5″×10″ samples were cut and weighed. The yield was then calculated to be Y=(150 in²)/M, where Y is the yield in in²/lb and M is the mass of the sample in pounds.

Density was calculated using the yield and the measured thickness of the film. D=1/(Y×T), where D is the density of the film in lbs/in³, Y is the yield in in²/lb, and T is the thickness in inches.

Porosity is defined in terms of the density, where P=1−d_{f}/dₒ. P is the porosity in %. dₒ is the original polymer density, d_{f} is the film density.

Opacity was measured by ASTM D589-94 (15°/Diffuse Illuminant A, 89% Reflectance Backing). It was measured as one hundred times the ratio of the diffused light reflected by the sample backed by a black body to the diffused light reflected of the sample backed by a white body. The result is reported as a percentage. 100% indicates a perfectly opaque sample.

Flex stiffness was measured by an internal testing method. A 4″×4″ square was cut. The sample was gently curled in the direction to test (MD or TD) and the two opposing edges were held together. Those edges were secured in a holder and the holder was fixed into place. A load cell with a cross bar was lowered so that it forced the curled part of the film to flex across the entire 4″ of exposed curled edge. The resistance of the film to that flexing action was measured by the load cell. Since the result was measured across 4″, the resistance was divided by 4″ to report a number in grams/inch.

WVTR was measured by modified ASTM E96-95, Procedure E. Procedure E calls for a desiccant method, but a water method was used instead. A test dish was filled with water ½″-1″ from the top. The test film was placed at the top and sealed around the edges. The dish was then placed in an oven at 100° F. and 20% relative humidity. The water loss was checked every 24 hours until the rate became constant. The WVTR was then calculated as: WVTR=G/(t×A)×(90/80), where WVTR=water vapor transmission rate, G=weight loss at steady state, t=time interval between measurements, and A=area of the cup mouth. The 90/80 factor converted the conditions from an 80% relative humidity difference to a 90% relative humidity difference, as outlined in ASTM E96-95, Procedure E.

### EXAMPLES

Sample 1 is a blend of 99% Dow C-104-01 (C₂C₃ block copolymer from Dow)+0.99% XJ-015 (random C₂C₃ copolymer from Sunoco)+0.01% γ-quinacridone for use as a beta nucleating agent. It was extruded at 254° C. and cast onto a chill roll through a slot die. The chill roll was set to 122° C. and the contact time was 38 seconds. After cooling, the cast sheet was heated to 85° C. and stretched 5.2× in the machine direction. The sample was then heated to 145° C. and a subjected to a transverse direction stretch of 8.2× at 13%/sec. The sample was heat set at 150° C. and wound onto a roll.

Sample 2 is a blend of 90% BI4020NSP (beta nucleated C₂C₃ block copolymer from Sunoco)+10% EOD-01-30 (metallocene-catalyzed polypropylene from AtoFina). It was extruded at 260° C. and cast onto a chill roll through a slot die. The chill roll was set to 120° C. and the contact time was 33 seconds. After cooling, the cast sheet was heated to 85° C. and stretched 5.9× in the machine direction. The sample was then heated to 147° C. and stretched in the transverse direction 7.7× at 16%/sec. The sample was wound onto a roll without a heat set.

Sample 3 is a blend of 90% BI4020NSP (beta nucleated C₂C₃ block copolymer from Sunoco)+10% X50251 (metallocene-catalyzed polypropylene from Basell). It was extruded at 250° C. and cast onto a chill roll through a slot die. The chill roll was set to 120° C. and the contact time was 38 seconds. After cooling, the cast sheet was heated to 85° C. and stretched 5.8× in the machine direction. The sample was then heated to 145° C. and stretched in the transverse direction 8.5× at 17%/sec. The sample was heat set at 152° C. and wound onto a roll.

Sample 4 is a blend of 99% Dow C-104-01 (C₂C₃ block copolymer from Dow)+0.99% XJ-015 (random C₂C₃ copolymer from Sunoco)+0.01% γ-quinacridone for use as a beta nucleating agent. It was extruded at 254° C. and cast onto a chill roll through a slot die. The chill roll was set to 122° C. and the contact time was 32 seconds. After cooling, the cast sheet was heated to 85° C. and stretched 5.9× in the machine direction. The sample was then heated to 145° C. and a subjected to a transverse direction stretch of 8.5× at 19%/sec. The sample was heat set at 150° C. and wound onto a roll.

Sample 5 is a blend of 90% BI4020NSP (beta nucleated C₂C₃ block copolymer from Sunoco)+10% EOD-01-30 (metallocene-catalyzed polypropylene from AtoFina). It was extruded at 260° C. and cast onto a chill roll through a slot die. The chill roll was set to 120° C. and the contact time was 33 seconds. After cooling, the cast sheet was heated to 85° C. and stretched 3.5× in the machine direction. The sample was then heated to 145° C. and stretched in the transverse direction 7.2× at 9%/sec. The sample was wound onto a roll without a heat set.

Sample 6 is a blend of 90% BI4020NSP (beta nucleated C₂C₃ block copolymer from Sunoco)+10% SRD4-189 (C₂C₄ copolymer from Dow). It was extruded at 251° C. and cast onto a chill roll through a slot die. The chill roll was set to 119° C. and the contact time was 38 seconds. After cooling, the cast sheet was heated to 85° C. and stretched 6.0× in the machine direction. The sample was then heated to 145° C. and stretched in the transverse direction 8.0× at 15%/sec. The sample heat set at 155° C. and wound onto a roll.

Sample 7 is a blend of 99.99% XJ-015 (C₂C₃ random copolymer from Sunoco)+0.01% γ-quinacridone (beta nucleating agent). It was extruded in the range of about 240° C.-260° C. and cast onto a chill roll through a slot die. The chill roll was set to 122° C. and the contact time was 32 seconds. After cooling, the cast sheet was heated to 85° C. and stretched 5.3× in the machine direction. The sample was then heated to 150° C. and stretched in the transverse direction 10.3× at 20%/sec. The sample was wound onto a roll without a heat set.

Sample 8 is B021SP, a beta nucleated propylene homopolymer from Sunoco. It was extruded at 252° C. and cast onto a chill roll through a slot die. The chill roll was set to 120° C. and the contact time was 32 seconds. After cooling, the cast sheet was heated to 85° C. and stretched 5.0× in the machine direction. The sample was then heated to 146° C. and stretched in the transverse direction 10.6× at 20%/sec. The sample was heat set at 150° C. and wound onto a roll.

Sample 9 is a blend of 90% BI4020NSP (beta nucleated C₂C₃ block copolymer from Sunoco)+10% EOD-01-30 (metallocene-catalyzed polypropylene from AtoFina). It was extruded at 260° C. and cast onto a chill roll through a slot die. The chill roll was set to 120° C. and the contact time was 33 seconds. After cooling, the cast sheet was heated to 85° C. and stretched 5.2× in the machine direction. The sample was then heated to 147° C. and stretched in the transverse direction 8.1× at 15%/sec. The sample was wound onto a roll without a heat set.

Sample 10 is a blend of 87.7% BI4020NSP (beta nucleated C₂C₃ block copolymer from Sunoco)+12.3% of a master batch of 65% CaCO3 in XJ-015 (C₂C₃ random copolymer from Sunoco). It was extruded at 254° C. and cast onto a chill roll through a slot die. The chill roll was set to 120° C. and the contact time was 37 seconds. After cooling, the cast sheet was heated to 80° C. and stretched 5.0× in the machine direction. The sample was then heated to 141° C. and stretched in the transverse direction 7.4× at 12%/sec. The sample was wound onto a roll without a heat set.

Sample 11 is 240WTL, a commercially available opaque label film made from polypropylene and calcium carbonate. For a comparable coverage, the flex stiffness is much lower than the beta nucleated polypropylene films.

Sample 12 is a blend of 40% calcium carbonate in XJ-015 (random C₂C₃ copolymer from Sunoco) with no beta-nucleating agent. Although the density of this was very low, the stiffness was far lower than the beta nucleated low density films.

Sample 13 is a blend of 67% BI4020NSP (beta nucleated C₂C₃ block copolymer from Sunoco)+23% of a master batch of 65% CaCO₃ in XJ-015 (C₂C₃ random copolymer from Sunoco) and 10% EOD-01-30 (metallocene-catalyzed polypropylene from AtoFina). It was extruded at 259° C. and cast onto a chill roll through a slot die. The chill roll was set to 120° C. and the contact time was 38 seconds. After cooling, the cast sheet was heated to 82° C. and stretched 4.7× in the machine direction. The sample was then heated to 154° C. and stretched in the transverse direction 7.6× at 12%/sec. The sample was wound onto a roll without a heat set.

Sample 14 is a blend of 67% BI4020NSP (beta nucleated C₂C₃ block copolymer from Sunoco)+23% of a master batch of 65% CaCO3 in XJ-015 (random copolymer from Sunoco) and 10% EOD-01-30 (metallocene-catalyzed polypropylene from AtoFina). It was extruded at 259° C. and cast onto a chill roll through a slot die. The chill roll was set to 120° C. and the contact time was 38 seconds. After cooling, the cast sheet was heated to 82° C. and stretched 5.1× in the machine direction. The sample was then heated to 153° C. and stretched in the transverse direction 7.6× at 13%/sec. The sample was wound onto a roll without a heat set.

Sample 15 is 100% BI4020NSP (beta nucleated C₂C₃ block copolymer from Sunoco). It was extruded at 254° C. and cast onto a chill roll through a slot die. The chill roll was set to 120° C. and the contact time was 41 seconds. After cooling, the cast sheet was heated to 82° C. and stretched 3.7× in the machine direction. The sample was then heated to 145° C. and stretched in the transverse direction 6.2× at 7%/sec. The sample was wound onto a roll without a heat set.

Sample 16 is 100% BI4020NSP (beta nucleated C₂C₃ block copolymer from Sunoco). It was extruded at 254° C. and cast onto a chill roll through a slot die. The chill roll was set to 120° C. and the contact time was 41 seconds. After cooling, the cast sheet was heated to 77° C. and stretched 3.7× in the machine direction. The sample was then heated to 150° C. and stretched in the transverse direction 6.2× at 7%/sec. The sample was wound onto a roll without a heat set.

Sample 17 is a blend of 90% BI4020NSP (beta nucleated C₂C₃ block copolymer from Sunoco)+10% SRD4-189 (C₂C₄ copolymer from Dow). It was extruded at 261° C. and cast onto a chill roll through a slot die. The chill roll was set to 119° C. and the contact time was 38 seconds. After cooling, the cast sheet was heated to 82° C. and stretched 5.1× in the machine direction. The sample was then heated to 145° C. and stretched in the transverse direction 7.2× at 13%/sec. The sample was wound onto a roll without a heat set stage.

Sample 18 is 100% BI4020NSP (beta nucleated C₂C₃ block copolymer from Sunoco). It was extruded at 257° C. and cast onto a chill roll through a slot die. The chill roll was set to 90° C. and the contact time was 38 seconds. After cooling, the cast sheet was heated to 82° C. and stretched 4.7× in the machine direction. The sample was then heated to 149° C. and stretched in the transverse direction 8.5× at 14%/sec. The sample was wound onto a roll without a heat set.

Sample 19 is 100% BI4020NSP (beta nucleated C₂C₃ block copolymer from Sunoco). It was extruded at 260° C. and cast onto a chill roll through a slot die. The chill roll was set to 120° C. and the contact time was 38 seconds. After cooling, the cast sheet was heated to 82° C. and stretched 3.6× in the machine direction. The sample was then heated to 145° C. and stretched in the transverse direction 6.6× at 7%/sec. The sample was wound onto a roll without a heat set.

Sample 20 is a blend of 90% BI4020NSP (beta nucleated C₂C₃ block copolymer from Sunoco)+10% SRD4-189 (C₂C₄ copolymer from Dow). It was extruded at 249° C. and cast onto a chill roll through a slot die. The chill roll was set to 120° C. and the contact time was 38 seconds. After cooling, the cast sheet was heated to 85° C. and stretched 6.0× in the machine direction. The sample was then heated to 145° C. and stretched in the transverse direction 8.0× at 15%/sec. The sample was heat set at 160° C. and wound onto a roll.

Sample 21 is a blend of 75% 3371 (propylene homopolymer from AtoFina), 24% SB786 (C₂C₃ block copolymer from Basell), 1% Dow C-104-01 (C₂C₃ block copolymer from Dow), and 0.01% γ-quinacridone for use as a beta nucleating agent. It was extruded at 235° C. and cast onto a chill roll through a slot die. The chill roll was set to 120° C. and the contact time was 32 seconds. After cooling, the cast sheet was heated to 85° C. and stretched 5.0× in the machine direction. The sample was then heated to 145° C. and stretched in the transverse direction at 20%/sec. The sample was heat set at 151° C. and wound onto a roll.

| | | | | | | | |
|---|---|---|---|---|---|---|---|
| | Area Draw | | | TAPPI | | | MD Flex |
| | MD Draw × | Thickness | Density | Opacity | WVTR | Yield | Stiffness |
| Sample | TD Draw | gauge | g/cm³ | % | g/m²/day | in²/lb | g/in |

| | | | | | | | | |
|---|---|---|---|---|---|---|---|---|
| 1 | 185-1 | 43 | 387 | 0.30 | 99 | 1560 | 24,625 | 6.2 |
| 2 | 141-B-22 | 46 | 410 | 0.25 | 98 | 2300 | 25,300 | 9.0 |
| 3 | 185-5A | 49 | 319 | 0.28 | 98 | 1740 | 30,500 | 3.7 |
| 4 | 185-1B | 50 | 283 | 0.29 | 98 | 1210 | 33,250 | 2.9 |
| 5 | 141-B16 | 23 | 530 | 0.31 | 99 | 1850 | 17,900 | 9.5 |
| 6 | 180-2A | 48 | 216 | 0.32 | 97 | 770 | 39,400 | 1.4 |
| 7 | 185-2A | 55 | 123 | 0.60 | 90 | 151 | 38,300 | 0.7 |
| 8 | 185-8 | 53 | 100 | 0.74 | 78 | 43 | 37,400 | 0.7 |
| 9 | 141-B-24 | 42 | 420 | 0.26 | 98 | 1700 | 23,800 | 8.0 |
| 10 | 150-E4 | 37 | 450 | 0.26 | 99 | 2800 | 23,800 | 4.9 |
| 11 | 240 WTL | 50 | 185 | 0.62 | | 7 | 24,000 | 2.9 |
| 12 | Exp 1 | 40 | 350 | 0.32 | | 3300 | 25,000 | 2.8 |
| 13 | 171-2B | 36 | 561 | 0.28 | 99 | 3100 | 17,300 | 9.7 |
| 14 | 171-2C | 39 | 603 | 0.27 | 99 | 3800 | 17,000 | 10.5 |
| 15 | 150-A-9 | 23 | 580 | 0.32 | 99 | 1920 | 14,800 | 10.4 |
| 16 | 150-A-10 | 23 | 570 | 0.32 | 99 | 2040 | 15,400 | 10.1 |
| 17 | 171-4B | 37 | 455 | 0.31 | 98 | 1110 | 19,700 | 10.2 |
| 18 | 171-3A | 40 | 500 | 0.31 | 99 | 800 | 18,600 | 13.8 |
| 19 | 141-A16 | 24 | 970 | 0.30 | | | 9,400 | 38.0 |
| 20 | 180-2B | 48 | 180 | 0.39 | | | 40,300 | 0.9 |
| 21 | 210-7 | 37 | 210 | 0.26 | | 3300 | 34,000 | 3.1 |

Samples 1-5 show that even with high total area draw ratios in excess of 20, and more preferably in excess of 40, the resulting films have a low density no greater than 0.31 g/cm³, a high opacity of 98 or greater, a high WVTR in excess of 1200 g/m²/day and high stiffness properties (e.g., a flex stiffness of at least 2.9 g/in., and up to 9.5 g/in).

Examples 6-8 show that using a random ethylene/propylene copolymer (Example 7) or a beta nucleated polypropylene homopolymer (Example 8), neither of which are block copolymers within the scope of this invention, under similar conditions as a block copolymer (Example 6), did not produce a film with the same enhanced properties as the film employing the block copolymer in accordance with this invention (e.g., flex stiffness is low, density is high, etc.)

Examples 9-14 show that materials made from beta-polypropylene precursors without additives exhibit superior properties to other opaque films. Samples 11 and 12 were made from a polypropylene based resin and calcium carbonate but no beta-nucleating agent. While these latter samples have similar yield as films of this invention, the stiffness values are substantially lower than Examples 9, 10, 13 and 14, which are films within the scope of this invention.

Examples 15-18 show that increasing the area draw ratio of films employing a ethylene/propylene block copolymer within the scope of this invention can either improve coverage or improve stiffness while maintaining all other properties intact. Note that the reduced WVTR of sample 18 is due to the lower crystallization temperature resulting in a lower initial beta crystal content. Examples 2, 5, and 9, and particular Example 9, show that high area draw ratios do not reduce the WVTR under similar area draw conditions.

Examples 19 and 20 demonstrate the wide range of thickness available with the films of this invention.

Example 21 shows that the films can be made from blends with 25% block copolymer and 75% homopolymer. The block copolymer must be present (see examples 7 and 8), but it does not need to be the major component.

| | | Cast | Cast | Draw | MD | MD | Quench | TD Draw | TD Heat | TD |
|---|---|---|---|---|---|---|---|---|---|---|
| | Extruder | Temp | Speed | Rate | Draw | Temp | Time | Temp | Set | Draw |
| Sample | RPM | ° C. | m/min | %/min | X | ° C. | Sec | ° C. | ° C. | x |
| 185-1 | 28 | 122 | 2.0 | 13 | 5.2 | 85 | 38 | 145 | 150 | 8.2 |
| 185-1B | 28 | 122 | 2.4 | 16 | 5.9 | 85 | 33 | 145 | 150 | 8.5 |
| 185-2A | 28 | 122 | 2.4 | 17 | 5.3 | 85 | 38 | 150 | 150 | 10.3 |
| 185-5A | 30 | 122 | 2.2 | 19 | 5.8 | 85 | 32 | 145 | 152 | 8.5 |
| 185-8 | 30 | 120 | 2.4 | 9 | 5.0 | 85 | 33 | 146 | 150 | 10.6 |
| 180-2A | 28 | 119 | 2.0 | 15 | 6.0 | 85 | 38 | 145 | 155 | 8.0 |
| 180-2B | 28 | 120 | 2.0 | 20 | 6.0 | 85 | 32 | 145 | 160 | 8.0 |
| 171-2B | 28 | 122 | 2.2 | 20 | 4.7 | 82 | 32 | 154 | 154 | 7.6 |
| 171-2C | 28 | 122 | 2.2 | 15 | 5.1 | 82 | 33 | 153 | 153 | 7.6 |
| 171-3A | 27.8 | 90 | 2.2 | 12 | 4.7 | 82 | 37 | 149 | 149 | 8.5 |
| 171-4B | 25 | 119 | 2.2 | 12 | 5.1 | 82 | 38 | 145 | 145 | 7.2 |
| 150-A-9 | 30 | 120 | 1.9 | 13 | 3.7 | 82 | 38 | 145 | 145 | 6.2 |
| 150-A-10 | 30 | 120 | 1.9 | 13 | 3.7 | 77 | 41 | 150 | 150 | 6.2 |
| 150-E-4 | 27 | 120 | 2.1 | 7 | 5.0 | 80 | 41 | 141 | 141 | 7.4 |
| 141-A-16 | 24 | 120 | 2.0 | 13 | 3.6 | 82 | 38 | 145 | 145 | 6.6 |
| 141-B-16 | 25 | 120 | 2.3 | 14 | 3.5 | 85 | 38 | 145 | 145 | 7.2 |
| 141-B-22 | 25 | 120 | 2.3 | 7 | 5.9 | 85 | 38 | 147 | 147 | 7.7 |
| 141-B-24 | 25 | 120 | 2.3 | 15 | 5.2 | 85 | 38 | 147 | 147 | 8.1 |
| 210-7 | 28 | 120 | 2.4 | 20 | 5.0 | 85 | 32 | 145 | 151 | 7.3 |

In accordance with this invention the polyolefin films that are fabricated have a density less than 0.40 g/cm³, more preferably less than 0.35 g/cm³ and most preferably less than 0.30 g/cm³.

Preferably the total area draw ratio employed in accordance with this invention is in excess of 20; more preferably at least 30, even more preferably at least 35 and most preferably at least 40 or higher. Films in accordance with this invention have been made at total area draw ratios exceeding 50. These values are apparent for the tables presented earlier herein.

Films with low density made via beta nucleation have high stiffness and coverage, while the high area draw improves the economics of producing these films. The films made in accordance with this invention have a thickness of at least 160 ga and can be as thick as 970 ga or higher. At less than 160 ga, the films have a higher frequency of breaks. The upper limits have not yet been determined, but at least 970 ga can be fabricated under the teachings of the present invention.

What we claim as our invention is the following:

1. A method of making a polyolefin film including the steps of:
blending a propylene block copolymer with a beta nucleating agent;
extruding a film layer from said blend; and
providing a total area draw ratio in excess of 20, where at least one part of the stretching occurs at <120° C., for forming the film with a density no greater than 0.40 g/cm³ and a thickness greater than 160 gauge.

2. The method of claim 1, wherein the block copolymer polymer is a propylene/ethylene block copolymer.

3. The method of claim 1, wherein the density is under 0.35 g/cm³.

4. The method of claim 1, wherein the density is under 0.30 g/cm³.

5. The method of claim 1, wherein the step of providing the area draw ratio is carried out to provide a total area draw ratio of at least 30.

6. The method of claim 2, wherein the step of providing the area draw ratio is carried out to provide a total area draw ratio of at least 30.

7. The method of claim 3, wherein the step of providing the area draw ratio is carried out to provide a total area draw ratio of at least 30.

8. The method of claim 4, wherein the step of providing the area draw ratio is carried out to provide a total area draw ratio of at least 30.

9. The method of claim 1, wherein the step of providing the area draw ratio is carried out to provide a total area draw ratio of at least 35.

10. The method of claim 2, wherein the step of providing the area draw ratio is carried out to provide a total area draw ratio of at least 35.

11. The method of claim 3, wherein the step of providing the area draw ratio is carried out to provide a total area draw ratio of at least 35.

12. The method of claim 4, wherein the step of providing the area draw ratio is carried out to provide a total area draw ratio of at least 35.

13. The method of claim 1, wherein the step of providing the area draw ratio is carried out to provide a total area draw ratio of at least 40.

14. The method of claim 2, wherein the step of providing the area draw ratio is carried out to provide a total area draw ratio of at least 40.

15. The method of claim 3, wherein the step of providing the area draw ratio is carried out to provide a total area draw ratio of at least 40.

16. The method of claim 4, wherein the step of providing the area draw ratio is carried out to provide a total area draw ratio of at least 40.

17. A biaxially oriented polyolefin film including a blend of a propylene block copolymer and a beta nucleating agent, said film having a density less than 0.40 g/cm³ and a thickness greater than 160 gauge.

18. The film of claim 17, wherein the propylene block copolymer constitutes at least 20% of the composition.

19. The film of claim 17, wherein the propylene block copolymer is a propylene/ethylene block copolymer.

20. The film of claim 17 being an ink jet printable substrate.

21. The film of claim 17, wherein said density is less than 0.35 g/cm³.

22. The film of claim 17, wherein said density is less than 0.30 g/cm³.
